(19) United States
(12) Patent Application Publication
(10) Pub. No.: US 2012/0289181 A1
(43) Pub. Date: Nov. 15, 2012

(54) IN-VEHICLE EMERGENCY CALL SERVICE REGISTRATION AND CALL SETUP USING FOLLOW-ON REQUEST

(75) Inventors: Jean-Baptiste Bertrand Bourdu, South Lake Tahoe, CA (US); Prashant Dogra, San Diego, CA (US); Nikolai Konrad Leung, Takoma Par, MD (US); Kushang S. Desai, San Diego, CA (US)

(73) Assignee: QUALCOMM Incorporated, San Diego, CA (US)

(21) Appl. No.: 13/284,377

(22) Filed: Oct. 28, 2011

Related U.S. Application Data
(60) Provisional application No. 61/485,494, filed on May 12, 2011.

(51) Int. Cl. H04W 4/22

(52) U.S. Cl. 455/404.1

(57) ABSTRACT

A follow-on request is used in the registration request of an eCall-only mode in-vehicle system (IVS) to keep the connection alive between the registration and the emergency call setup in order to speed up the overall signaling process before sending eCall data for the eCall-only mode IVS. In this manner, two separate connections are not needed in order to perform the registration of the IVS on the mobile network and then the emergency call setup. Only one connection is used and maintained throughout registration and call setup processes. This speeds up the eCall emergency registration and call setup. In an implementation, the registration request with the follow-on request is provided only when the eCall-only IVS is activated for use in an emergency call (i.e., in an initial registration of the eCall-only IVS).

### CLAIM OF PRIORITY UNDER 35 U.S.C. §119

The present Application for Patent claims priority to Provisional Application No. 61/485,494, filed on May 12, 2011, and assigned to the assignee hereof and hereby expressly incorporated by reference herein.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless network may support communication for a number of terminals. A terminal may place an emergency call in response to an emergency event. An emergency call is a call for emergency services (e.g., police, fire, medical, or other emergency services) and may also be referred to as an emergency services call. An emergency call may be initiated by a user dialing a well-known emergency number such as “911” in North America or “112” in Europe. It may be desirable to efficiently exchange signaling between the terminal and the wireless network for the emergency call.

eCall refers to an in-vehicle emergency call service. In the event of a collision involving the vehicle, the eCall In-Vehicle System (IVS) establishes an emergency call via a mobile network (also referred to as a wireless network or a cellular network) to emergency agencies, e.g., a Public-Safety Answering Point (PSAP). The IVS can be provisioned for “eCall-only” service or for “mixed-mode eCall” service. In “mixed-mode eCall” service, the system can be used to perform emergency eCalls as well as non-emergency, subscription-based calls. In “eCall-only” mode, the system can only be activated to make eCalls.

More particularly, dedicated eCall devices, such as those associated with a vehicle and designed for the sole purpose to make emergency calls in the event of an accident, are generally referred to as devices that operate in eCall-only mode. That is, eCall-only mode requires at least that the device does not perform mobility management procedures, including registration on a Public Land Mobile Network (PLMN), except when the device is attempting to initiate and during an emergency call, or when the device is attempting to initiate a test or reconfiguration connection.

An IVS in eCall-only mode does not register on the mobile network before the eCall is triggered. In case of an eCall emergency trigger, two operations are performed: (1) the IVS has to register on the mobile network and then (2) the IVS initiates the eCall emergency call. Conventionally, registration on the mobile network for an eCall is performed, and then setup information for initiating the emergency call is sent to the network from the IVS. Performing the registration and sending the setup information are performed as two separate operations, requiring two separate RR/RRC (radio resource/radio resource control) connections one after the other, separated by a time lag. This time lag is idle time which delays the emergency agencies from getting information, which can delay the emergency agencies from attending to the incident that triggered the eCall emergency.

### SUMMARY

A follow-on request is used in the registration request of an eCall-only mode in-vehicle system (IVS) to keep the connection alive between the registration and the emergency call setup in order to speed up the overall signaling process before sending eCall data for the eCall-only mode IVS.

In an implementation, the network access server (NAS) information element (IE) follow-on request is used in the registration request of an eCall-only mode IVS to keep the RR/RRC connection alive between the registration and the emergency call setup. In this manner, two separate RR/RRC connections are not needed in order to perform the registration of the IVS on the mobile network and then the emergency call setup. Only one RR/RRC connection is used and maintained throughout registration and call setup processes. This speeds up the eCall emergency registration and call setup.

In an implementation, the registration request with the follow-on request is provided only when the eCall-only IVS is activated for use in an emergency call (i.e., in an initial registration of the eCall-only IVS).

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an exemplary network deployment;

FIG. 2 shows a message flow for establishing an eCall by a terminal;

FIG. 3 shows a process performed by a terminal for eCall registration using a follow-on request;

FIG. 4 shows a process performed by a network to support eCall registration using a follow-on request;

FIG. 5 is an operational flow of a method of establishing an emergency call via a mobile network; and

FIG. 6 is a block diagram of an exemplary IVS wireless device or apparatus that may be provisioned to operate as an eCall-only capable device illustrative of various implementations disclosed herein; and

FIG. 7 is a block diagram of an exemplary wireless voice/data module of the IVS of FIG. 6 communicatively coupled to the base station/RAN and MSC/VLR of FIG. 1 during an emergency call.

### DETAILED DESCRIPTION

Techniques for supporting eCalls are described herein. An eCall is an emergency call that may (i) be initiated automatically by a wireless terminal due to a trigger event (e.g., a vehicle involved in an accident) or manually by a user and (ii) include additional data sent automatically by the terminal to a recipient entity, e.g., a Public Safety Answering Point (PSAP). The additional data may include vehicle identification, vehicle location, trigger event, etc., and may be sent inband along a voice path or out-of-band via separate signaling or data/text transfer. A terminal that supports eCall may be (i) a normal wireless terminal that subscribes to normal services such as voice calls, packet data, text messages, video, etc. or (ii) a terminal that supports only eCalls, which is referred to as an eCall-only terminal. An eCall comprises an emergency call (similar to an emergency call initiated by a user dialing “911”) plus automatic sending of additional data to the recipient entity.

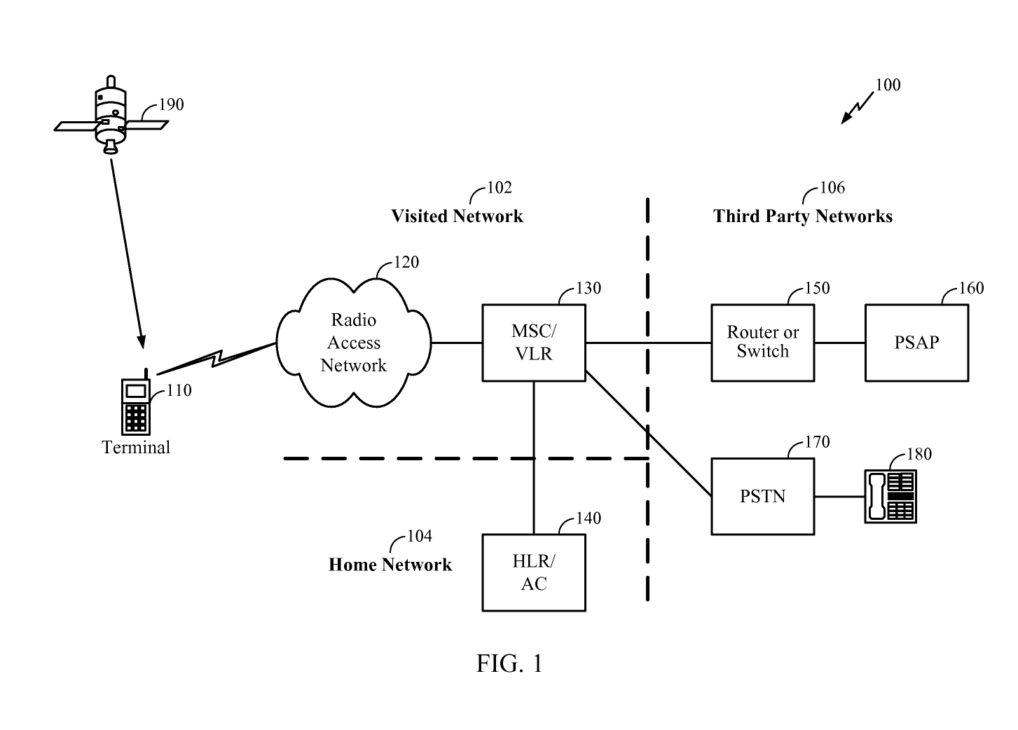

FIG. 1 shows an exemplary network deployment 100, which may include a visited network 102, a home network 104, and third party networks 106. Visited network 102 may also be referred to as a Visited Public Land Mobile Network (V-PLMN), a serving network, etc. Home network 104 may also be referred to as a Home PLMN (H-PLMN). Visited network 102 may be a serving network for a terminal 110, which may be roaming from its home network 104. Visited network 102 and home network 104 may be the same network if terminal 110 is not roaming.

Visited network 102 may include a radio access network (RAN) 120, a Mobile Switching Center (MSC)/Visitor Location Register (VLR) 130, and other network entities not shown in FIG. 1 for simplicity. RAN 120 may be a Global System for Mobile Communications (GSM) network, a Wideband Code Division Multiple Access (WCDMA) network, a General Packet Radio Service (GPRS) access network, a Long Term Evolution (LTE) network, CDMA 1× network, a High Rate Packet Data (HRPD) network, an Ultra Mobile Broadband (UMB) network, etc. GSM, WCDMA, GPRS and LTE are part of Universal Mobile Telecommunication System (UMTS) and are described in documents from an organization named “3rd Generation Partnership Project” (3GPP). CDMA 1× and HRPD are part of cdma2000, and cdma2000 and UMB are described in documents from an organization named “3rd Generation Partnership Project 2” (3GPP2). The MSC may perform switching functions for circuit-switched calls and may also route Short Message Service (SMS) messages. The VLR may store registration information for terminals that have registered with visited network 102.

Home network 104 may include a Home Location Register (HLR)/Authentication Center (AC) 140 and other network entities not shown in FIG. 1 for simplicity. The HLR may store subscription information for terminals that have service subscription with home network 104. The AC may perform authentication for terminals having service subscription with home network 104.

Third party networks 106 may include a router or switch 150 (e.g., a PSAP selected router), a PSAP 160, a Public Switched Telephone Network (PSTN) 170, and possibly other network entities not shown in FIG. 1. Router or switch 150 may route calls between MSC 130 and PSAP 160. PSAP 160 may be responsible for answering emergency calls and may also be referred to as an Emergency Center (EC). PSAP 160 may be operated or owned by a government agency, e.g., a county or city. PSTN 170 may provide telephone services for conventional wireline telephones, such as a telephone 180.

FIG. 1 shows only some of the network entities that may be present in visited network 102 and home network 104. For example, visited network 102 may include network entities supporting packet-switched calls and other services as well a location server to assist in obtaining terminal location.

Terminal 110 may be stationary or mobile and may also be referred to as a mobile station (MS) in GSM and CDMA 1×, a user equipment (UE) in WCDMA and LTE, an access terminal (AT) in HRPD, a SUPL enabled terminal (SET) in Secure User Plane Location (SUPL), a subscriber unit, a station, etc. Terminal 110 may be a device such as a cellular phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. Terminal 110 may also be devices which communicate with a personal navigation device (PND), such as by short-range wireless, infrared, wireline connection, or other connection--regardless of whether satellite signal reception, assistance data reception, and/or position-related processing occurs at the device or at the PND. Also, terminal 110 is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also included. Terminal 110 may also be a dedicated In-Vehicle System (IVS), which may be permanently attached to (and possibly part of) a vehicle.

Terminal 110 may have a service subscription with home network 104 and may be roaming in visited network 102, as shown in FIG. 1. Terminal 110 may receive signals from RAN 120 in visited network 102 or may communicate with the RAN to obtain communication services. Terminal 110 may also communicate with home network 104 for communication services when not roaming (not shown in FIG. 1). Terminal 110 may also receive signals from one or more satellites 190, which may be part of a satellite positioning system (SPS). An SPS typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). Terminal 110 may measure signals from satellites 190 and obtain pseudo-range measurements for the satellites. Terminal 110 may also measure signals from base stations in RAN 120 and obtain timing and/or signal strength measurements for the base stations. The pseudo-range measurements, timing measurements and/or signal strength measurements may be used to derive a position estimate for terminal 110. A position estimate may also be referred to as a location estimate, a position fix, etc.

Terminal 110 may have an International Mobile Equipment Identity (IMEI), which is a unique number assigned to the terminal. Terminal 110 may be used for a service subscription of a user. The service subscription may be associated with an International Mobile Subscriber Identity (IMSI), which is a unique number assigned to a subscription for GSM and UMTS networks. The service subscription may also be associated with a Mobile Subscriber Integrated Services Digital Network Number (MSISDN), which is a telephone number for the service subscription. The IMSI may be used as a key for the service subscription in a subscriber database in HLR 140. The MSISDN may be dialed by other users to connect calls to terminal 110 used for the service subscription. The IMSI, the MSISDN, and other subscription information may be stored in a Subscriber Identity Module (SIM) or a Universal Subscriber Identity Module (USIM), which may be inserted into terminal 110. Terminal 110 may also have no SIM/USIM, in which case terminal 110 may have only an IMEI but no IMSI or MSISDN.

Wireless networks may be required to support different types of emergency calls. One type may include “normal” emergency calls originated by users dialing well-known emergency numbers such as “911” in North America and “112” in Europe. Another type may include eCalls, which are emergency calls that may have the characteristics described above. Support for eCalls may be required by the European Union and by other world regions and/or countries. An eCall may be different from a normal emergency call in the manners in which the call is placed and the additional emergency related data that may be sent to establish the eCall and used to process the eCall. For example, the additional data may indicate how the eCall was initiated, a registration request, a follow-on request, information pertaining to the IVS (e.g., eCall-only mode or mixed-mode), a vehicle type and vehicle identification number (VIN), a timestamp, a position estimate and position confidence flag, the direction of travel, the number of passengers (e.g., with fastened seatbelts), a service provider for the terminal (if any), a trigger type (e.g., deployed airbags, bumper sensors, etc.), and possibly other information. The additional data may enable an eCall to be setup using a connection previously established for registration of the IVS or terminal making the eCall. as described further herein, and an accurate geographic location of the terminal to be provided to a PSAP.

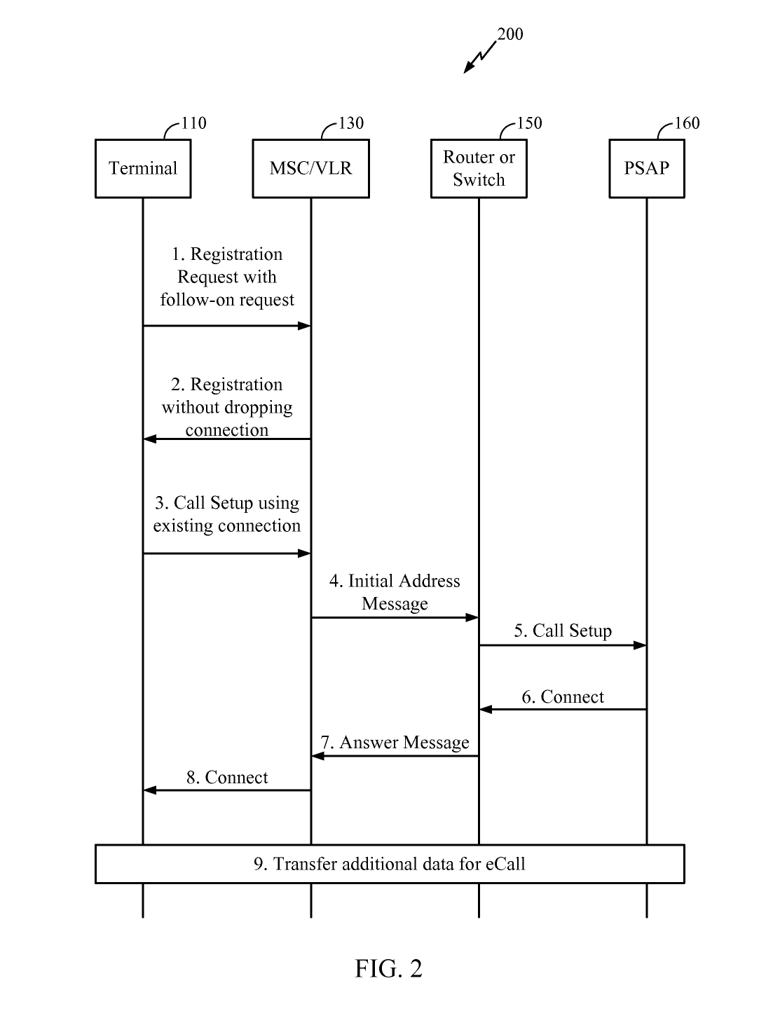

FIG. 2 shows a design of a message flow 200 for establishing (e.g., registering and placing) an eCall by terminal 110 in FIG. 1. For simplicity, some network entities (e.g., RAN 120) and some less pertinent signaling messages are not shown in FIG. 2. Terminal 110 may generate registration request message containing data and/or signaling to indicate that the terminal is an eCall-only IVS and is seeking registration on the mobile network. The registration message may also comprise a follow-on request to keep the connection (e.g., the RR/RRC connection) alive between the registration of the terminal and the emergency call setup. The follow-on request may comprise an indicator in the registration request message (e.g., in a field or information element of the message). The indicator may also be implemented in other manners in an IE or elsewhere in the registration request message, for example.

This registration request with the follow-on request may be sent to the MSC/VLR 130 to request registration for service without dropping the connection (step 1). MSC/VLR 130 may receive the message and may respond by registering the terminal 110 on the mobile network without dropping the existing connection (step 2).

Terminal 110 may then send a Call Setup message to place an eCall using the existing (i.e., the previously established and maintained) connection (step 3). The Call Setup message may be a conventional Call Setup message known to those of skill in the art.

MSC/VLR 130 may receive the message and may send an Initial Address Message to router or switch 150 to originate a call for terminal 110 (step 4). Router or switch 150 may then send a Call Setup message to PSAP 160 to establish the call for terminal 110 (step 5). PSAP 160 may return a Connect message to router or switch 150 (step 6), which may then return an Answer Message to MSC/VLR 130 (step 7). MSC/VLR 130 may then return a Connect message to terminal 110 (step 8). Terminal 160 may transfer additional data for the eCall to the network for possible forwarding to PSAP 160 (step 9). The transfer of additional data may also be performed in steps 3, 4 and 5 or some other steps prior to step 9. In any case, the eCall may be established for terminal 110 after steps 8 and 9. Terminal 110 may then communicate with PSAP 160 for the eCall.

An eCall may be initiated automatically by terminal 110 (e.g., due to a vehicle collision) or manually by a user (e.g., a vehicle occupant). Terminal 110 may be any device supporting eCall functionality such as a cellular phone, an IVS, etc. In one design, terminal 110 may provide an eCall indicator in the emergency call setup. The eCall indicator may convey one of the following: Manually Initiated eCall (MIeC) originated by the user, or Automatically Initiated eCall (AIeC) originated by the terminal.

The eCall indicator may be used by a wireless network to differentiate the eCall from normal emergency calls, to filter or route the eCall to an appropriate PSAP (e.g., a PSAP equipped to receive eCalls), and/or for other purposes such as to identify the terminal as an eCall-only IVS. The eCall indicator may be conveyed by terminal 110 in various manners during emergency call setup. The eCall indicator may be sent in a Service Request message, an Emergency SETUP message, a SETUP message, or some other message sent by terminal 110.

As noted above, dedicated eCall IVSs, known as eCall-only IVSs, are those IVSs associated with a vehicle and designed for the sole purpose of making emergency calls such as in the event of an accident. Generally, an eCall-only IVS differs from other eCall IVSs and conventional mobile communications devices (with or without eCall capabilities) in that the eCall-only IVS does not perform mobility management procedures (MMPs)—such as registration on a Public Land Mobile Network (PLMN)—except when the IVS is attempting to initiate an emergency call (or, in some instances, when the IVS is attempting to initiate a test or reconfiguration connection upon request of the user). Also, after registering and placing an emergency call, the eCall-only device may then be permitted to perform MMPs in order to allow call-back by the PSAP as well as normal voice and data communication functionality, SMS messaging, or other such wireless device capabilities for the duration of the emergency (or a suitably estimated period of time). Up until the moment an accident actually occurs, however, the eCall-only IVS is maintained in an inactive state.

In the event of an accident, an in-vehicle sensor may be triggered that activates the eCall-only IVS. Since this IVS was inactive prior to the accident, it is first necessary for the IVS to effect a connection (i.e., register) with an available network before it can transmit any data regarding the accident. Ideally this connection is made to the home network (HPLMN), but when the IVS is “roaming” (i.e., when the IVS's home network is unavailable or unreachable) the IVS must register on a roaming network (VPLMN) if one is available.

In an implementation, when an eCall-only IVS transitions from the inactive state to the active state (e.g., upon triggering by an accident involving the vehicle), a network access server (NAS) information element (IE) “follow-on request” in the registration request is used to keep the RR/RRC connection alive between the registration and the emergency call setup in order to speed up the overall signaling process before sending eCall data. In this manner, two separate RR/RRC connections are not needed in order to perform the registration of the IVS on the mobile network and then the emergency call setup. Only one RR/RRC connection is used and maintained throughout registration and call setup processes. This speeds up the eCall emergency registration and call setup.

The NAS IE follow-on request is used in a registration request so that the mobile network does not release the RR/RRC connection that has been established with the IVS. Thus, the RR/RRC connection for registration can be used right away by the IVS to initiate the eCall emergency call. With this feature, no time is wasted releasing the RR/RRC connection for registration, being idle, and the setting of another RR/RRC connection for the eCall emergency setup. In this manner, the response team is able to get incident (e.g., accident) information faster.

Thus, instead of setting up two RR/RRC connections, the IVS only needs one RR/RRC connection by reusing the first one (the one used for registration). This not only saves time but also lowers the chance of failures and having a second RR/RRC connection request rejected by the network or dropped.

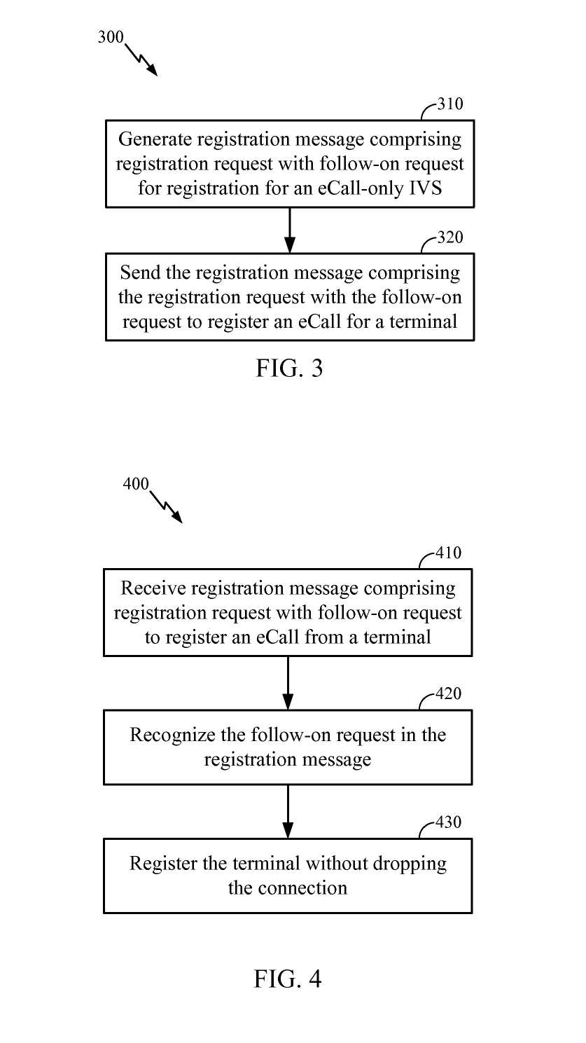

FIG. 3 shows a process 300 performed by a terminal for eCall registration using a follow-on request. At 310, the terminal may generate a registration request message comprising an indicator that the terminal is an eCall-only IVS and comprising a follow-on request to maintain the connection for the subsequent call setup. At 320, the terminal may send the message to register the terminal for an eCall. The registration message may allow the network to learn of the terminal's presence.

In an implementation, the registration request message may comprise a Service Category information element having at least one bit used for the eCall indicator. In one design, the at least one bit used for the eCall indicator may comprise (i) a first bit indicating a follow-on request and (ii) a second bit indicating an eCall-only IVS. In another design, the at least one bit used for the indicator may comprise a single bit indicating a registration request with a follow-on request for an eCall-only IVS.

The indicator provides an indication to the network, which may be the visited network or the home network, that the IVS is in an emergency. In this manner, the home network does not need to separately determine (e.g., using a lookup table or by subsequent messaging, probing, or signaling) that the IVS is in an emergency and is an eCall-only IVS.

FIG. 4 shows a design of a process 400 performed by a wireless network to support eCall registration using a follow-on request. At 410, the network may receive a message to register an eCall from a terminal. The message may comprise a follow-on request instead of being a typical or conventional registration message. At 420, the network may obtain an indicator from the message. The indicator may comprise information that the terminal is an eCall-only IVS and requests a follow-on (i.e., a request to maintain the connection for a subsequent eCall). At 430, based on the indicator in the message, the network may register the terminal with the network without dropping the connection for a subsequent call for emergency services. After the terminal is registered, then an emergency call may be placed. Thus, even after the IVS is registered using the registration message with the follow-on request, the emergency call itself must be initialized and placed.

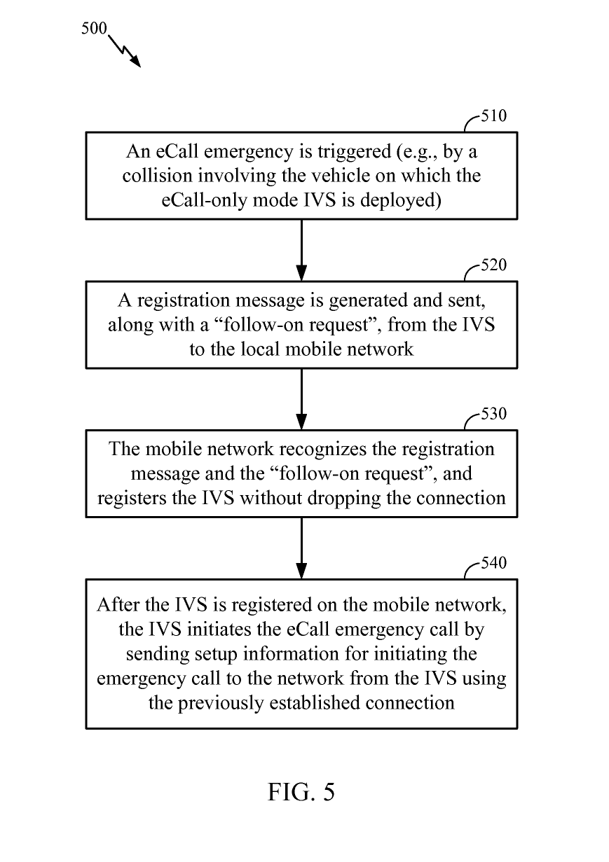

FIG. 5 is an operational flow of a method 500 of establishing an emergency call via a mobile network. At 510, an eCall emergency is triggered (e.g., by a collision involving the vehicle on which the eCall-only mode IVS is deployed). This trigger changes the IVS from an inactive state to an active state seeking registration. At 520, a registration message is generated and sent, along with a follow-on request, from the IVS to the local mobile network. The follow-on request is part of the initial registration.

At 530, the mobile network recognizes the registration message and the follow-on request, and registers the IVS without dropping the connection. At 540, after the IVS is registered on the mobile network, the IVS initiates the eCall emergency call by sending setup information for initiating the emergency call to the network from the IVS using the previously established connection.

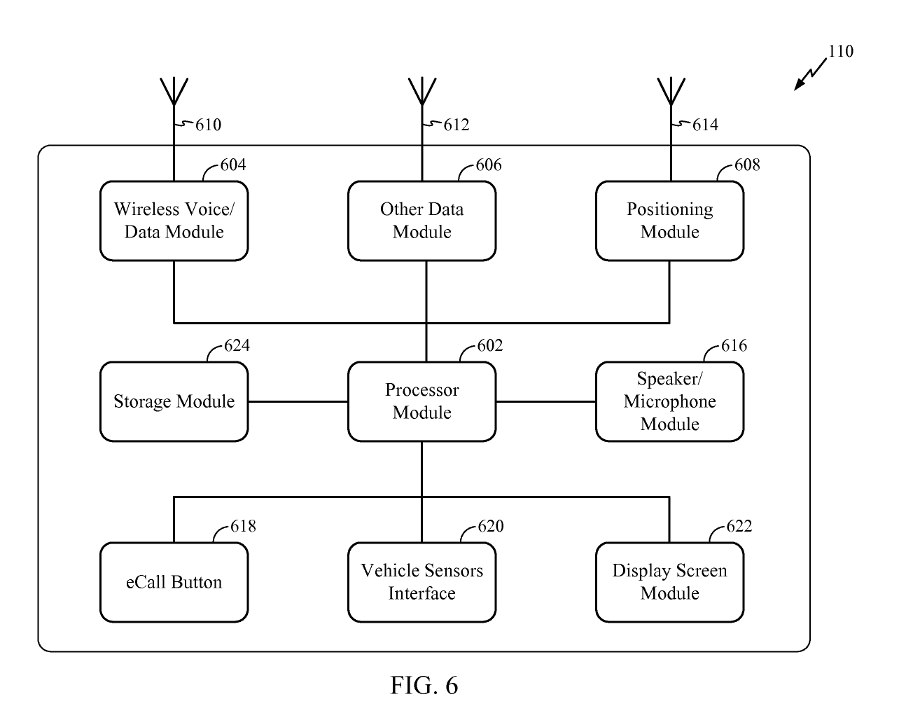

FIG. 6 is a block diagram of an exemplary IVS (e.g., terminal 110) wireless device or apparatus that may be provisioned to operate as an eCall-only capable device illustrative of various implementations disclosed herein. The IVS or terminal 110 may include a processor module 602 coupled to a plurality of wireless modules that enable the IVS 110 to communicate wirelessly. For example, the wireless modules may include a wireless voice/data module 604, an other data module 606 (e.g., Bluetooth module), and a positioning module 608 (e.g., GPS module), although the IVS 110 is not limited to the illustrated wireless modules. Each of the illustrated wireless modules is coupled to an antenna 610, 612 and 614, respectively. Although the antennas 610, 612 and 614 are shown as separate antennas, a single unitary antenna may also be used and coupled to the modules 604-608.

The processor module 602 may also be coupled to a speaker/microphone module 616, an eCall button 618, a vehicle sensors interface 620 and a display screen module 622. Furthermore, the processor module 602 may be coupled to a storage module 624 that may include information that provisions the IVS 110 as an eCall-only capable device. The eCall button 618 may be used to manually initiate an emergency call in the event of an accident or other situation requiring attention or assistance from emergency services. The vehicle sensors interface 620 may be coupled to sensors (not illustrated) deployed in a vehicle and designed to detect an accident condition that may require attention or assistance from emergency services. Such vehicle sensors may be attached to an airbag deployment mechanism, vehicle body integrity sensors, or the like.

The IVS 110 may be configured to transmit and receive voice and data communications to and from the MSC 130 via the RAN 120 during emergency calls (following registration). The MSC 130 enables emergency information from the IVS 110 to be communicated to the PSAP 160 via the router or switch 150 or the PSTN 160. Such emergency information may be communicated to the PSAP 160 once the IVS initiates an emergency call using the appropriate emergency number (e.g., 112, 911, 000, etc.) stored in the device. The emergency information may include voice communications directly from a user and via the speaker/microphone module 616, data generated from sensors coupled to the vehicle sensors interface 620, and positioning information from the positioning module 608.

As mentioned earlier, the IVS 110 may be provisioned as an eCall-only device, and such provisioning information may be stored in the storage module 624. The storage module 624 may be a nonvolatile storage, volatile storage, a Subscriber Identity Module (SIM), a Universal Subscriber Identity Module (USIM), or any other suitable storage capable element.

The speaker/microphone module 616 may be used during voice calls between the IVS 110 and the PSAP 160. Telematics application specific buttons, such as the eCall button 618, may be used to activate the eCall-only IVS or otherwise initiate the generation and transmittal of specific emergency data messages and/or emergency voice communications to the PSAP 160 via the eCall system. Furthermore, initiation of data communication may also be accomplished automatically via vehicle sensors, such as sensors coupled to the airbag deployment mechanism.

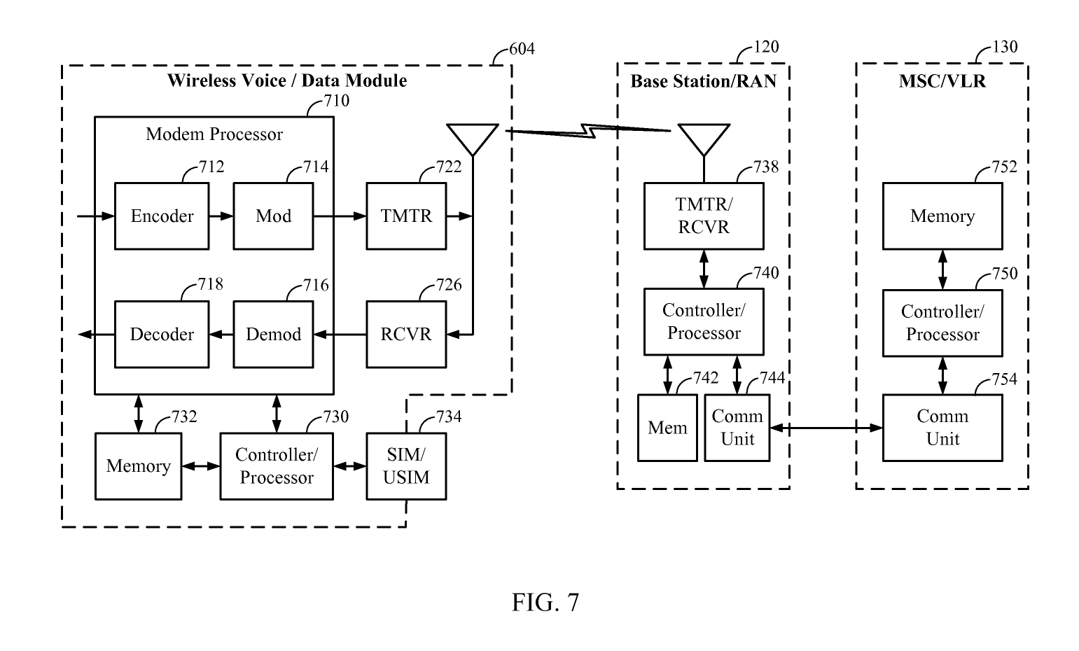

Each of the wireless modules 604-608 includes a transmitter to transmit and encode voice and data messages using antennas 610-614, respectively, via an over-the-air protocol such as CDMA, WCDMA, GSM, TDMA, or the like. The wireless modules 604-608 may also be configured to transmit by other wireless communications, such as satellite communications. Each of the wireless modules 604-608 also includes a receiver to receive and decode voice and data messages from the cell site, the MSC 130, and the PSAP 160, or any other component associated with the communications network 100. Such received voice and data messages may be received via an over-the-air protocol such as CDMA, WCDMA, GSM, TDMA, or the like. The wireless modules 604-608 may also be configured to receive other wireless communications, such as satellite communications. The transmitters and receivers may be integrated transceiver devices. These elements are discussed in more detail in FIG. 7.

FIG. 7 is a block diagram of an exemplary wireless voice/data module 604 of the IVS 110 of FIG. 6 communicatively coupled to the RAN 120 and MSC/VLR 130 of FIG. 1 during an emergency call. As illustrated in FIG. 7, when the IVS 110 is active during an emergency, an encoder 712 may receive data and messages to be sent by wireless voice/data module 604. Encoder 712 may process (e.g., encode and interleave) the data and messages and provide coded data and coded signaling. A modulator (Mod) 714 may further process (e.g., modulate, channelize, and scramble) the coded data and signaling and provide output samples. A transmitter (TMTR) 722 may condition (e.g., convert to analog, filter, amplify, and frequency upconvert) the output samples and generate an uplink signal, which may be transmitted to one or more base stations in RAN 120.

Wireless voice/data module 604 may also receive downlink signals transmitted by one or more base stations. A receiver (RCVR) 726 may condition (e.g., filter, amplify, frequency downconvert, and digitize) a received signal and provide input samples. A demodulator (Demod) 716 may process (e.g., descramble, channelize, and demodulate) the input samples and provide symbol estimates. A decoder 718 may process (e.g., deinterleave and decode) the symbol estimates and provide decoded data and messages sent to wireless voice/data module 704. Encoder 712, modulator 714, demodulator 716, and decoder 718 may be implemented by a modem processor 710. These units may perform processing in accordance with the radio technology (e.g., GSM, WCDMA, LTE, etc.) used by the wireless network with which wireless voice/data module 604 is in communication. A controller/processor 730 may direct the operation of various units at wireless voice/data module 604. Processor 730 and/or other modules at terminal 110 may perform or direct process 300 in FIG. 3, and/or other processes for the techniques described herein. Memory 732 may store program codes and data for wireless voice/data module 604. A SIM/USIM 734 may store subscription information for a service subscription used for wireless voice/data module 604.

At RAN 120, a transmitter/receiver 738 may support radio communication with IVS 110 wireless voice/data module 604 as well as other terminals (both IVSs and other mobile communication devices). A controller/processor 740 may perform various functions for communication with the terminals. For the uplink, the uplink signal from wireless voice/data module 604 may be received and conditioned by receiver 738 and further processed by controller/processor 740 to recover the data and messages sent by wireless voice/data module 604. For the downlink, data and messages may be processed by controller/processor 740 and conditioned by transmitter 738 to generate a downlink signal, which may be transmitted to wireless voice/data module 604 and other terminals. Memory 742 may store program codes and data for RAN 120. A communication (Comm) unit 744 may support communication with MSC/VLR 130 and other network entities.

At MSC/VLR 130, a controller/processor 750 may perform various functions to support communication services for the terminals. Memory 752 may store program codes and data for MSC/VLR 130. A communication unit 754 may support communication with RAN 120 and other network entities. Controller/processor 750 and/or other modules at MSC/VLR 130 may perform or direct all or part of process 400 in FIG. 4, and/or other processes for the techniques described herein.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Skilled artisans will further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Call registration techniques may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of establishing an emergency call, comprising:
triggering an emergency in a vehicle comprising an in-vehicle system (IVS) for making an emergency call via a mobile network;
generating a registration message at the IVS; and
transmitting the registration message, and a follow-on request, from the IVS to the mobile network, via a connection between the IVS and the mobile network, for registering the IVS on the mobile network.

2. The method of claim 1, wherein the IVS is registered on the mobile network responsive to the registration message being received at the mobile network, and the connection between the IVS and the mobile network is maintained.

3. The method of claim 2, further comprising initiating an emergency call by the IVS over the mobile network, using the connection, after the IVS is registered on the mobile network.

4. The method of claim 1, wherein the IVS is only operable to place a call in emergency mode.

5. The method of claim 1, wherein the connection is an RR/RRC (radio resource/radio resource control) connection.

6. The method of claim 1, wherein the connection between the IVS and the mobile network is maintained based on the follow-on request received by the mobile network.

7. The method of claim 1, wherein the registration message comprises the follow-on request.

8. The method of claim 7, wherein the registration message comprises a first bit indicating the follow-on request and a second bit indicating an eCall-only IVS.

9. The method of claim 1, wherein the registration message with the follow-on request is provided only when the IVS is activated for use in an emergency call.

10. The method of claim 9, wherein the IVS is activated for use in an emergency call in an initial registration of an eCall-only IVS.

11. The method of claim 1, wherein the mobile network is a visited network.

12. The method of claim 1, wherein the mobile network is a home network.

13. An apparatus for establishing an emergency call, comprising:
means for triggering an emergency in a vehicle comprising an in-vehicle system (IVS) for making an emergency call via a mobile network;
means for generating a registration message at the IVS; and
means for transmitting the registration message, and a follow-on request, from the IVS to the mobile network, via a connection between the IVS and the mobile network, for registering the IVS on the mobile network.

14. The apparatus of claim 13, wherein the IVS is registered on the mobile network responsive to the registration message being received at the mobile network, and the connection between the IVS and the mobile network is maintained.

15. The apparatus of claim 14, further comprising means for initiating an emergency call by the IVS over the mobile network, using the connection, after the IVS is registered on the mobile network.

16. The apparatus of claim 13, wherein the IVS is only operable to place a call in emergency mode.

17. The apparatus of claim 13, wherein the connection is an RR/RRC (radio resource/radio resource control) connection.

18. The apparatus of claim 13, wherein the connection between the IVS and the mobile network is maintained based on the follow-on request received by the mobile network.

19. The apparatus of claim 13, wherein the registration message comprises the follow-on request.

20. The apparatus of claim 19, wherein the registration message comprises a first bit indicating the follow-on request and a second bit indicating an eCall-only IVS.

21. The apparatus of claim 13, wherein the registration message with the follow-on request is provided only when the IVS is activated for use in an emergency call.

22. The apparatus of claim 21, wherein the IVS is activated for use in an emergency call in an initial registration of an eCall-only IVS.

23. The apparatus of claim 13, wherein the mobile network is a visited network.

24. The apparatus of claim 13, wherein the mobile network is a home network.

25. A computer-readable medium comprising instructions that cause a computer to:
trigger an emergency in a vehicle comprising an in-vehicle system (IVS) for making an emergency call via a mobile network;
generate a registration message at the IVS; and
transmit the registration message, and a follow-on request, from the IVS to the mobile network, via a connection between the IVS and the mobile network, for registering the IVS on the mobile network.

26. The computer-readable medium of claim 25, wherein the IVS is registered on the mobile network responsive to the registration message being received at the mobile network, and the connection between the IVS and the mobile network is maintained.

27. The computer-readable medium of claim 26, further comprising computer-executable instructions that cause the computer to initiate an emergency call by the IVS over the mobile network, using the connection, after the IVS is registered on the mobile network.

28. The computer-readable medium of claim 25, wherein the IVS is only operable to place a call in emergency mode.

29. The computer-readable medium of claim 25, wherein the connection is an RR/RRC (radio resource/radio resource control) connection.

30. The computer-readable medium of claim 25, wherein the connection between the IVS and the mobile network is maintained based on the follow-on request received by the mobile network.

31. The computer-readable medium of claim 25, wherein the registration message comprises the follow-on request.

32. The computer-readable medium of claim 31, wherein the registration message comprises a first bit indicating the follow-on request and a second bit indicating an eCall-only IVS.

33. The computer-readable medium of claim 25, wherein the registration message with the follow-on request is provided only when the IVS is activated for use in an emergency call.

34. The computer-readable medium of claim 33, wherein the IVS is activated for use in an emergency call in an initial registration of an eCall-only IVS.

35. The computer-readable medium of claim 25, wherein the mobile network is a visited network.

36. The computer-readable medium of claim 25, wherein the mobile network is a home network.

37. An apparatus for establishing an emergency call, comprising:
at least one processor that triggers an emergency in a vehicle comprising an in-vehicle system (IVS) for making an emergency call via a mobile network, and generates a registration message at the IVS; and
a transmitter that transmits the registration message, and a follow-on request, from the IVS to the mobile network, via a connection between the IVS and the mobile network, for registering the IVS on the mobile network.

38. The apparatus of claim 37, wherein the IVS is registered on the mobile network responsive to the registration message being received at the mobile network, and the connection between the IVS and the mobile network is maintained.

39. The apparatus of claim 38, wherein the at least one processor initiates an emergency call by the IVS over the mobile network, using the connection, after the IVS is registered on the mobile network.

40. The apparatus of claim 37, wherein the IVS is only operable to place a call in emergency mode.

41. The apparatus of claim 37, wherein the connection is an RR/RRC (radio resource/radio resource control) connection.

42. The apparatus of claim 37, wherein the connection between the IVS and the mobile network is maintained based on the follow-on request received by the mobile network.

43. The apparatus of claim 37, wherein the registration message comprises the follow-on request.

44. The apparatus of claim 43, wherein the registration message comprises a first bit indicating the follow-on request and a second bit indicating an eCall-only IVS.

45. The apparatus of claim 37, wherein the registration message with the follow-on request is provided only when the IVS is activated for use in an emergency call.

46. The apparatus of claim 45, wherein the IVS is activated for use in an emergency call in an initial registration of an eCall-only IVS.

47. The apparatus of claim 37, wherein the mobile network is a visited network.

48. The apparatus of claim 37, wherein the mobile network is a home network.
